(19) United States
(12) Patent Application Publication
(10) Pub. No.: US 2003/0005618 A1
(43) Pub. Date: Jan. 9, 2003

(54) Animal trap

(76) Inventor: Edward Flanagan, Oakley, MI (US)

Correspondence Address: SWARTZ & WILSON, P.L.C., SUITE 200, 908 COURT STREET, SAGINAW, MI, 48602, US

(21) Appl. No.: 09/900,641

(22) Filed: Jul. 9, 2001

(51) Int. Cl. A01M 23/26

(52) U.S. Cl. 43/88

(57) ABSTRACT

A leg hold trap for trapping an animal including a base pivotally mounting a pair of clamping jaws, and a pair of springs for moving the clamping jaws between open, spaced apart, set positions and closed leg clamping positions clamping the leg of an animal there-between. A pair of launch arms are mounted on each of the springs for reacting with the underlying terrain and upwardly launching the base and the clamping jaws as the clamping jaws are moving between the open and closed positions. The pairs of launching arms are swingably moveable about first and second spaced apart axes. The launch arms each include launching rods of a predetermined breadth and a launching pad of substantially increased breadth having a terminal end disposed between the axes.

### BACKGROUND OF THE INVENTION

1. Field of the Invention

This invention relates to a pan type leg hold animal trap, triggered by the weight of an animal, which is easier to set, and more effective at trapping an animal, and more particularly to new and improved mechanism for upwardly launching the trap as the trap jaws are closing on the leg of an animal.

2. Description of the Prior Art and Objects

Pan type animal traps have been provided heretofore such as that disclosed in U.S. Pat. No. 4,972,626 issued to Edward J. Medbetz on Nov. 27, 1990. Such traps include a base, a pair of jaws pivotally mounted on the base, a spring for moving the jaws between open set positions and closed leg clamping positions, and a pivotal pan which holds the jaws in the open set position until the an animal steps on the pan. The weight of the animal rotates the pan and disengages a pan holding dog whereby the trap is sprung to grip and trap the animal's leg.

Some wild animals have extremely sensitive touch and upon engaging the foreign trap pan, the animal will tend to quickly raise its leg which sometimes results in the animal escaping the trap or the trap engaging a lower portion of the animal's leg. It has been found advantageous to have the trap close on an upper portion of the leg having a higher leg volume and thus decrease the likelihood of an animal's leg breaking from the impact of the trap. If an animal's leg is broken, it is much easier for the animal to twist off the leg or, in some cases, chew off its own leg, allowing the animal to free itself on three legs. Accordingly, it is an object of the present invention to provide a new and novel animal trap which will more consistently trap an upper portion of an animal's leg having a higher leg volume.

It is another object of the present invention to provide a new and novel trap of the type described which will break fewer bones of the legs of animals trapped therein.

It is a further object of the present invention to provide a new and novel trap of the type described which will increase the average catch of sensitive animals stepping into the trap.

It is still a further object of the present invention to provide a new and novel trap of the type described which will decrease the loss of animals being trapped.

The broad concept of upwardly launching an animal trap, after it was sprung, was recognized early in U.S. Pat. No. 1,500,102 issued to A. A. Chantland on Oct. 3, 1911. U.S. Pat. No. 4,065,871 issued to Herbert H. Loeffler on Jan. 3, 1978, discloses an animal trap including a pair of inertial snubbers or dampers that underlie the trap and tend to upwardly displace the trap when the trap is sprung. The design of these snubbers retards the closing action of the trap as the snubbers will penetrate the underlying soft ground to substantially slow the closing action of the trap and sometimes allow an animal to escape. Moreover, the length of the prior art snubbers is substantial and thus when an animal steps on the trap, the long snubber arms will retard the trap closure due to the increased leverage thereof. Accordingly, it is another object of the present invention to provide a new and novel animal trap including mechanism for upwardly launching the trap after it has been sprung and while the clamping jaws are closing.

A further object of the present invention is to provide an animal trap of the type described including new and novel launch arms which are coupled to a jaw holding and releasing spring for movement therewith and to react with the underlying terrain and upwardly launch the trap after it is sprung.

Still another object of the present invention is to provide new and novel trap of the type described which includes a new and novel launching mechanism for upwardly launching the trap toward the animal's leg as it is being sprung.

As one might expect, the springs on such traps disclosed in the aforementioned patents, are quite strong and require a considerable force to move the clamping jaws from the closed positions to the open positions. Youngsters frequently attempt to set the trap by stepping on the jaw closing blades which are fixed to the springs. With either of the aforesaid prior art patents, the trap is unstable and will tend to tip when the closure blades are stepped on to set the trap. Accordingly, it is another object of the present invention to provide a new and novel trap of the type described which is easier to set than the prior art traps.

It is another object of the present invention to provide a new and novel trap of the type described which is more stable than the prior art traps when being set.

It is still another object to provide a new and novel trap which will be less likely to tip when the closure blades are stepped on to open the jaws.

It is another object of the present invention to provide a new and novel trap of the type described which will upwardly propel the trap and not project into the underlying ground.

It is a further object of the present invention to provide a new and novel trap of the type described which includes a plurality of launching arms each having a launching pad of substantially increased breadth for spreading the force applied thereto over a substantially greater area.

It should also be noted that the retarder mechanism which underlies the prior art trap illustrated in U.S. Pat. No. 4,065,871 is not fixed to the closure blades coupled to the springs that close the jaws. Accordingly, it is a further object of the present invention to provide a new and novel trap of the type described which has four launch arms fixed to the spring actuated closure blades upon which the trap will rest when the clamping jaws are in the closed positions.

Still another object of the present invention is to provide two laterally spaced launch arms on each of a pair of jaw closure blades for downwardly swinging to upwardly launch the jaws as they are closing.

It is a further object of the present invention to provide a new and novel trap of the type described which includes terminal ends that are disposed between the rotational axes of the launch arms.

A still further object of the present invention is to provide a new and novel leg hold trap of the type described which includes terminal ends that are disposed between the rotational axes of the launch arms when the clamping jaws are in the open set positions.

These and other objects of the present invention will become more readily apparent to those of ordinary skill in the art as the description thereof proceeds:

### SUMMARY OF THE INVENTION

A leg hold trap for trapping an animal's leg comprising: a base, a pair of leg clamping jaws pivotally mounted on the base for swinging movement in laterally opposite directions between open set positions and closed leg clamping positions clamped to the opposite sides of the animal's leg; a pair of longitudinally spaced springs mounted on the base for swinging movement to yieldably move the clamping jaws to the closed positions but allowing the jaws to move from closed positions to the open positions; jaw holding mechanism for releaseably holding the clamping jaws in the open positions but allowing the springs to move the jaws to the closed positions; and a pair of spaced apart launch arms fixed to each spring for movement therewith for upwardly launching the clamping jaws as the jaws are closing.

### DESCRIPTION OF THE DRAWINGS

The invention may be more readily understood by reference to the accompanying drawings, in which:

FIG. 1 is a front side elevational view of a leg hold trap constructed according to the present invention, illustrating the clamp jaws in the closed, sprung position taken along the line 1-1 of FIG. 5;

FIG. 2 is an opposite rear side elevational view thereof taken along the line 2-2 of FIG. 5;

FIG. 3 is an end elevational view thereof, taken along the line 3-3 of FIG. 5;

FIG. 4 is an opposite end elevational view taken along the line 4-4 of FIG. 5′

FIG. 5 is a top plan view of the trap illustrated in FIG. 2;

FIG. 6 is a bottom plan view thereof;

FIG. 7 is a bottom plan view, similar to FIG. 6, but illustrating the jaws in the open, set positions;

FIG. 8 is a top plan view of the trap illustrated in FIG. 7; and

FIG. 9 is a rear side elevational view of the trap in the open, set position, taken along the line 9-9 of FIG. 8.

### DESCRIPTION OF PREFERRED EMBODIMENT

A trap, generally designated 10, constructed according to the present invention, comprises a longitudinally extending base or frame, generally designated 12, having upper and lower sides 12A and 12B and a pair of longitudinally spaced upturned ends or ears 14 each having a pair of laterally spaced apertures 16 therethrough. In use, the base 12 is typically detachably coupled to a stake (not shown) by a chain 13 received in an aperture 15 provided in the frame 12. Also mounted on the frame 12 is a transverse cross piece 17 which mounts a horizontally disposed, U-shaped spring mount 19 having longitudinally spaced apart, laterally extending legs 23 and 25.

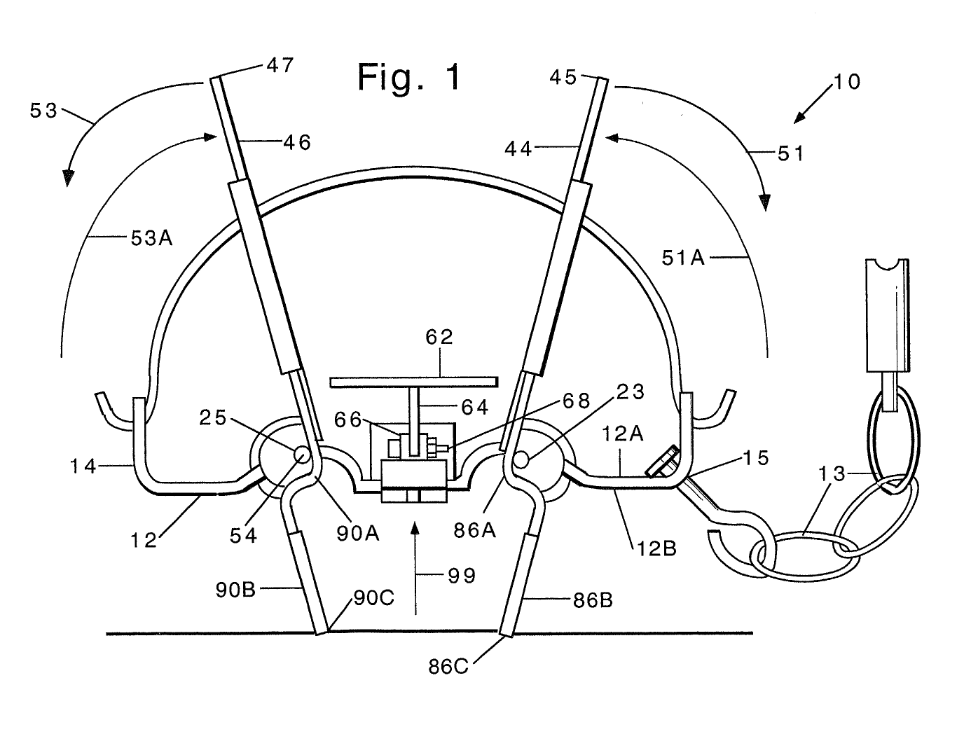

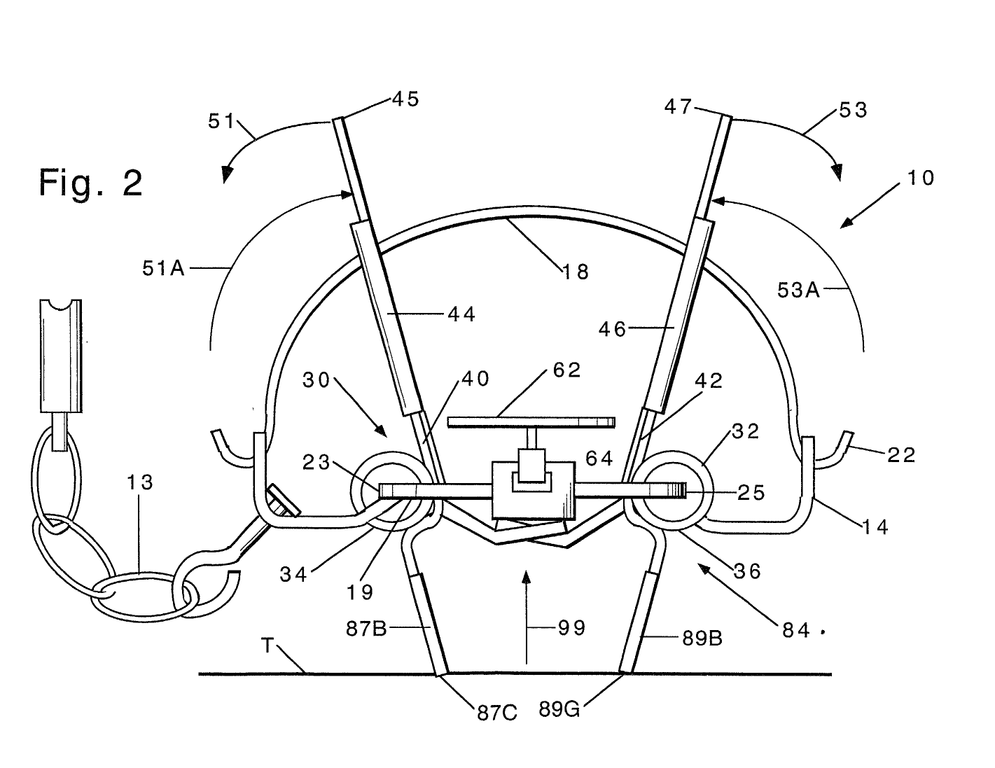

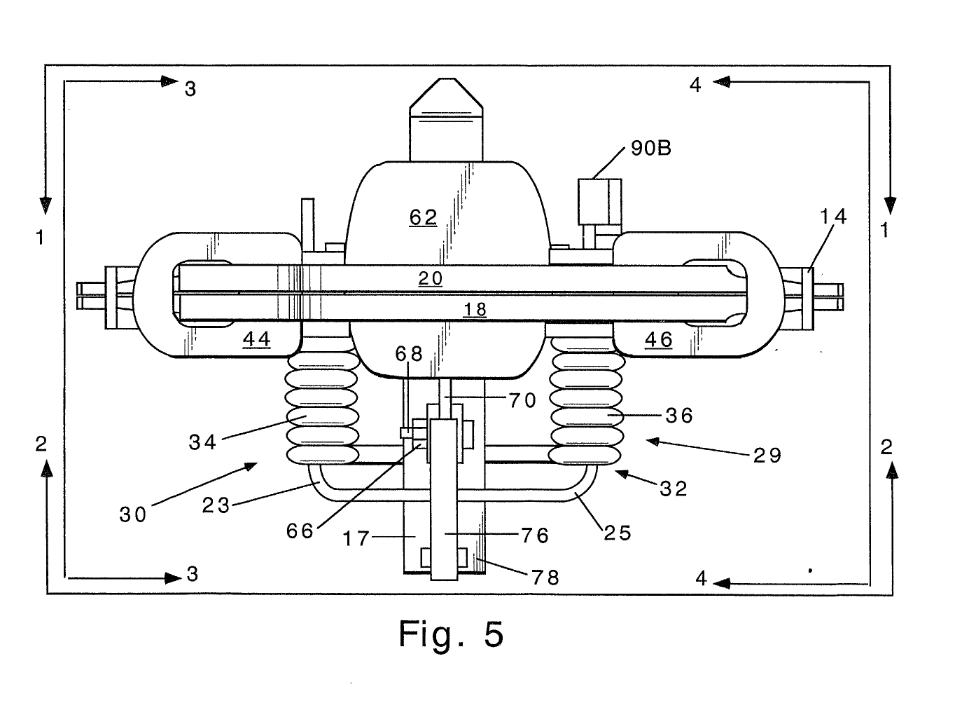

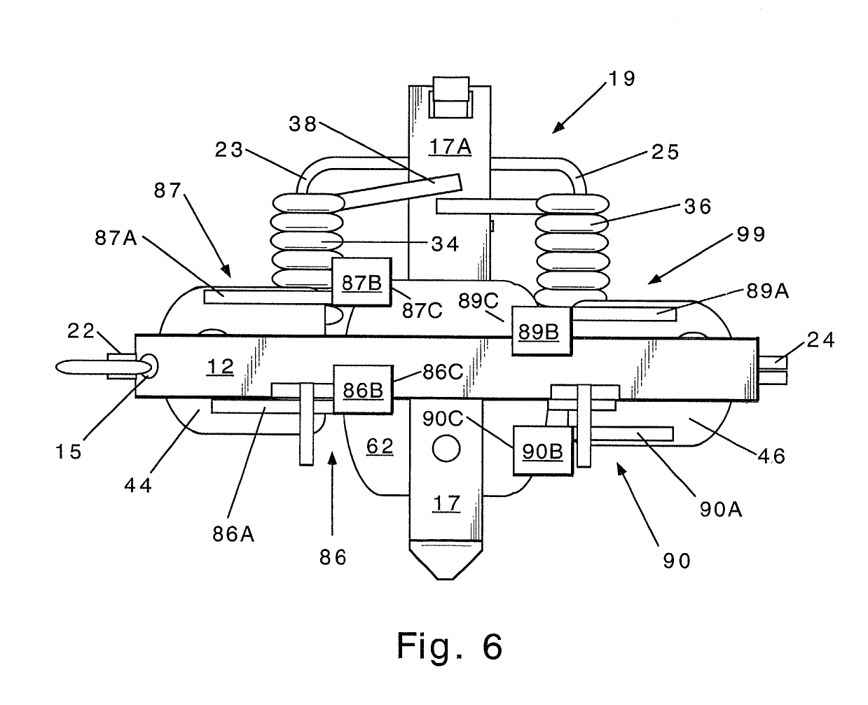

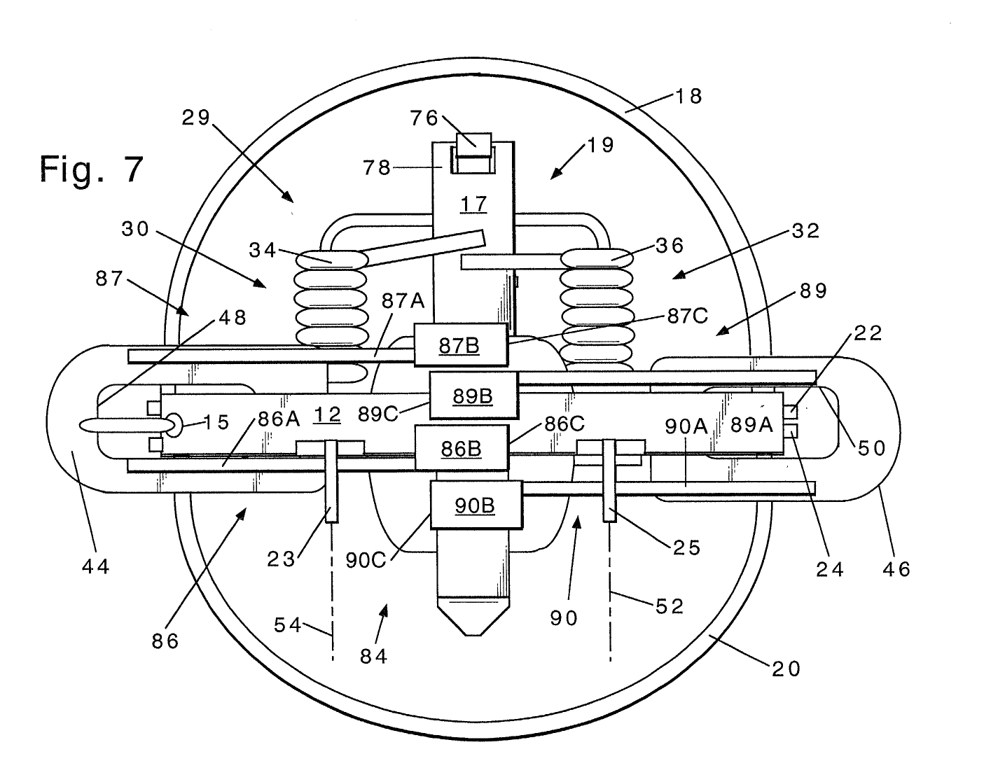

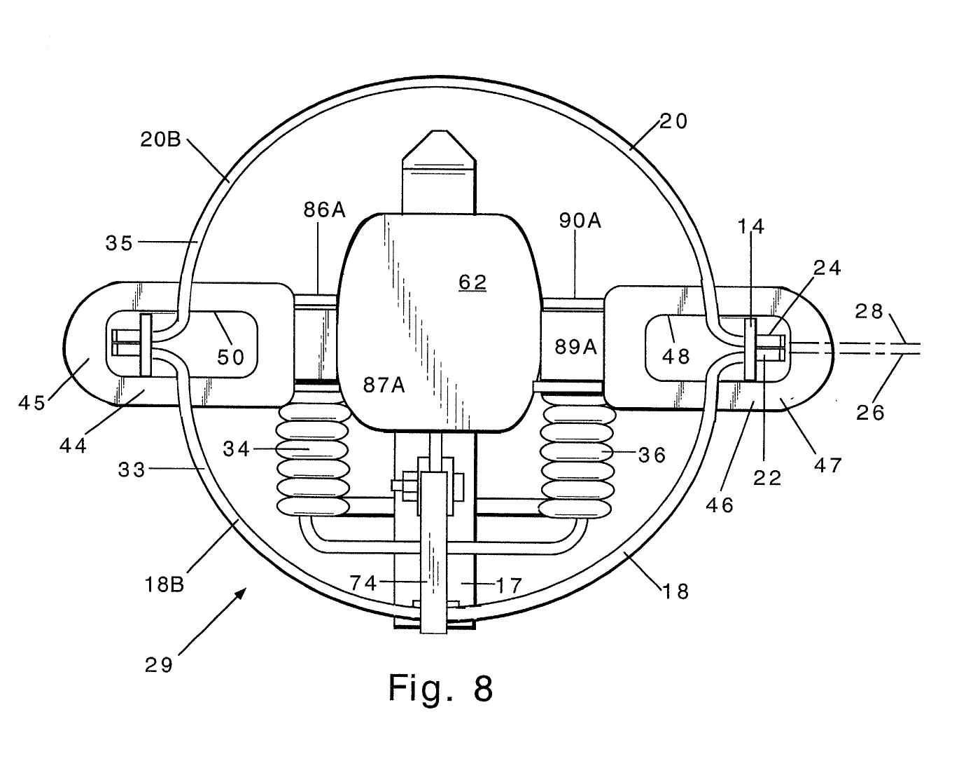

A pair of laterally adjacent, C-shaped leg clamping jaws 18 and 20 include terminal ends 22 and 24 swingably received in apertures 16 for swinging movement about longitudinal axes 26 and 28, respectively, between the closed leg clamping, upstanding sprung positions, illustrated in FIGS. 1-6, and the horizontally disposed, spread, open, set positions illustrated in FIGS. 7-9.

A spring assembly, generally designated 29, is provided for yieldably urging the clamping jaws 18 and 20 to move from the open set positions, illustrated in FIGS. 7-9, to the closed leg clamping positions illustrated in FIGS. 1-6. The spring assembly 29 includes a pair of springs, generally designated 30 and 32, including coil springs 34 and 36, respectively, fixed to a pair of jaw closure blades 44 and 46, respectively. The springs 30 and 32 are swingably mounted about the spring mount legs 23 and 25, respectively, of U-shaped spring mount 19, and having laterally outer terminal ends 38 bearing against the underside 17A of cross piece 17. The coil springs 34 and 36, are coiled about the legs 23 and 25, respectively. The laterally inner ends of the coil springs 34 and 36 include elongate straight terminal end portions 40 and 42, respectively, welded or otherwise suitably fixed to the undersides of a pair of jaw closure blades 44 and 46, respectively.

The closure blades 44 and 46 include elongate apertures 48 and 50, respectively, for slidably receiving the legs 33 and 35 of jaws 18 and 20, respectively. As the closure blades 44 and 46 are downwardly swinging from the jaw closing positions, illustrated in FIGS. 1-6, to the jaw releasing positions, illustrated in FIGS. 7-9, the coil springs 32 and 34 are tightened against the biasing force of the springs tending to force the jaws 18 and 20 to close. To open the blades 44 and 46, the terminal ends 45 and 47 of the closure blades 44 and 46 may be hand grasped or stepped on if desired.

The blades 44 and 46 are swingable about the transverse axes 52 and 54 (FIG. 1) of legs 23 and 25, respectively, of U-shaped spring mount 19, between the horizontally disposed set positions, illustrated in FIGS. 7-9 when the jaws 18 and 20 are open, and less spread apart, vertically inclined positions, illustrated in FIGS. 1-6 when the jaws 18 and 20 are closed.

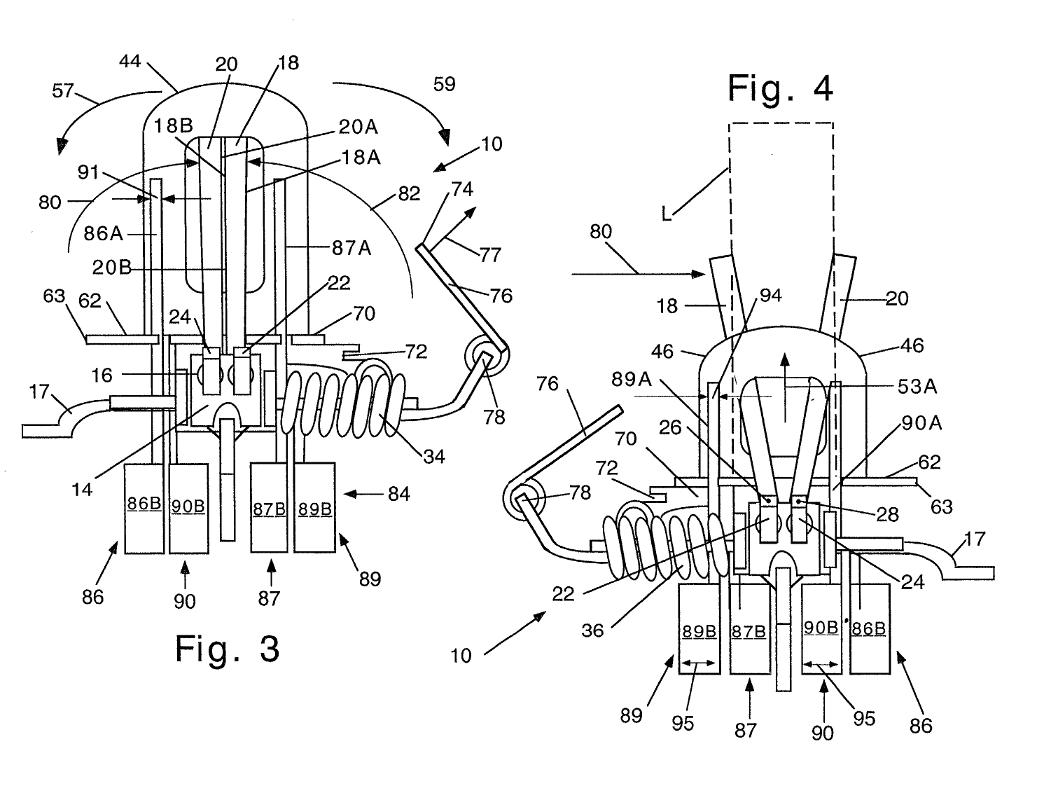

Apparatus, generally designated 60, is provided for detachably holding the jaws 18 and 20 in the open set positions, illustrated in FIGS. 7-9, and includes a trip pan, generally designated 62, mounted atop a support bar 64 which is pivotally mounted on frame supported ears 66 via a shaft 68 (FIG. 1). The underside of pan 62 mounts a keeper plate 70 (FIG. 3) having an outwardly opening terminal notch 72 which receives an opposing terminal end 74 of a pivotal dog, generally designated 76, that is swingably mounted on an extension 78 of the transverse bar 17.

The terminal dog end 74 is detachably received in the slot 72, when the jaws are in the open positions illustrated in FIGS. 7-9, to hold the clamping jaw 18 in the open position. When an animal steps on the top 63 of the trip pan 62, the end 74 of dog 76 will escape the slot 72 thereby allowing the dog 76 to freely swing upwardly, in the direction of the arrow 77, thereby releasing the jaws 18 and 20 for swinging movement, in the laterally opposite directions represented by the arrows 80 and 82, toward each other to the closed positions illustrated in FIGS. 1-6.

To preclude the animal's leg, schematically illustrated in chain lines at L in FIG. 4, touching the pan 62 from escaping between the clamping jaws 18 and 20 before the jaws close, and to insure that the jaws securely clamp ab upper part of the animal's leg, launching apparatus, generally designated 84, is provided and includes a pair of laterally spaced apart launching members 86 and 87 welded or otherwise suitably fixed to the closure blade 44 and a second pair of laterally spaced apart launching members 89 and 90 welded or otherwise suitably fixed to closure blade 46. The launch members 86 and 87 include bars 86A and 87A having a predetermined breadth 91, fixed, at their upper ends, to the underside of the closure blade 84 in laterally spaced relation. Welded or otherwise suitably fixed to the lower terminal end portions of the bars 86A and 87A are flat plates or launching pads 86B and 87B, respectively.

The launch members 89 and 90 include bars 89A and 90A, respectively, of a predetermined breadth 94, welded at their upper ends to the underside of blade 86. Welded to the lower terminal ends of the rods 89A and 90A are a third and fourth launching pad or plate 89B and 90B, respectively. The pads 89B and 90B have a lateral breadth 95 which is substantially greater than the breadth 94 of rods 86A.

As is illustrated in FIGS. 3, 4, 6, and 7, the bars 86A and 87A are transversely spaced apart relative to each other and relative to the bars 89A and 90A so that the bars 86A and 90A are laterally adjacent and the bars 87A and 89A are laterally adjacent when the jaws 18 and 20 are opened to the positions illustrated in FIGS. 7-9.

The pads 89B and 90B are laterally disposed on the bars 89A and 90A in a direction laterally opposite the disposition of pads 86B and 87B on the bars 86A and 87A so as to freely pass when they are in the horizontal positions illustrated in FIGS. 7-9. It is important to note that the terminal ends 86C, 87C, 89C, and 90C, of launching pads 86A, 87B, 89B, and 90B, respectively, are disposed between the rotational axes 52 and 54 of the blades 44, 46 and launching bars 44 and 46. As illustrated in FIG. 1, the bars 86A and 87A and the bars 89A and 90A pass over the upper sides of the legs 23 and 25, respectively.

THE OPERATION

It will be assumed that the trap 10 is initially in the closed sprung position, illustrated in FIGS. 1-6. In the rest positions shown in FIGS. 1-6, the four launch arms project downwardly the same distance below the underside of the frame 12, so that the trap 10 will be stable, self-supporting in the position illustrated in FIGS. 1-6, and less prone to tipping than the prior art. The terminal tip ends 86C, 87C, 89C and 90C will bear against the underlying terrain T.

The user will set the trap by downwardly pressing on the upper terminal ends 45 and 47 of the closure blades 44 and 46, respectively, in the direction of the arrows 51 and 53, respectively, allowing the clamping jaws 18 and 20 to open laterally outwardly, in the opposite directions represented by the arrows 57 and 59, to the open leg receiving positions, illustrated in FIGS. 7-9. Youthful individuals may prefer to step on the terminal blade ends 45 and 47 as opposed to using their hands to open the blades 44 and 46.

When the clamping jaws 18 and 20 are moved to the spread open positions, illustrated in FIGS. 7-9, the dog 76 is manually swung to a position overlying the jaw 18. The terminal end 74 of dog 76 is detachably received in the slot 70 whereby the dog 76 is held in the slot 72 and will temporarily prevent the trip pan 62 from tipping about the axis of shaft 60.

At this stage, the launching apparatus 84 is disposed in the generally horizontal positions illustrated in FIGS. 7-9.

When an animal's leg L steps into the trap and presses downwardly on the upper surface 63 of trip pan 62, the pan 62, depending on the direction of rotation about the axis of shaft 60, will tip on the shaft 60 to either upwardly or downwardly force the underlying slot 72 to escape the end 74 of dog or keeper 76. The keeper 76 will release the jaw 18 and swing upwardly in the direction of arrow 77 (FIG. 3). The coil springs 34 and 36 will force the closure blades 44 and 46 to swing upwardly about the pivot axes 23 and 25, respectively, in the direction of the arrows 51A and 53A, respectively, to bear against the laterally outer surfaces 18A and 20A of the clamping jaws 18 and 20, respectively, to close the inner surfaces 18B and 20B against opposite sides of the animal's leg L disposed there-between.

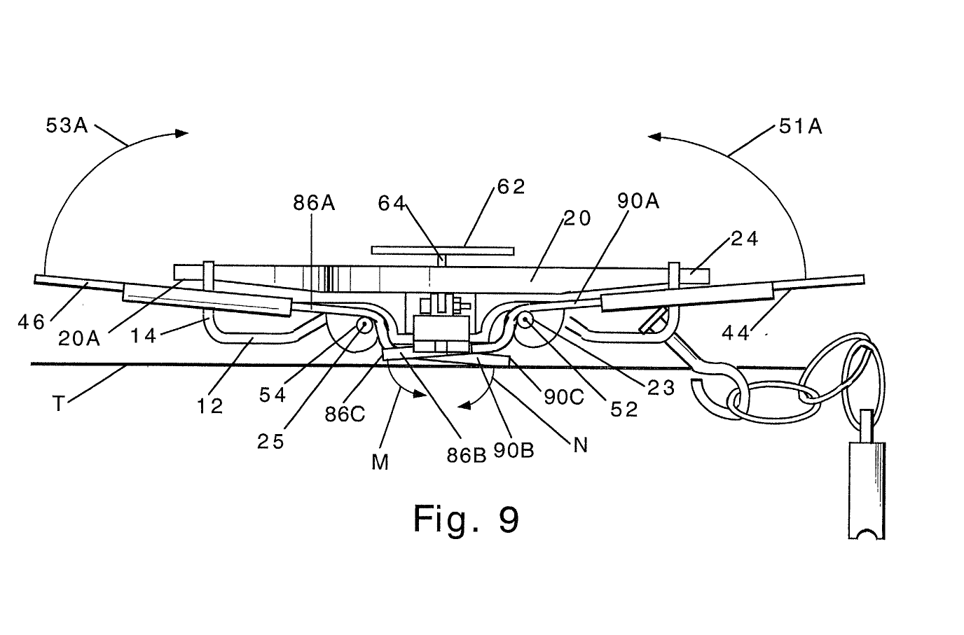

It should be realized, of course, that when an animal's leg L is trapped between the jaws 18 and 20, the surfaces 18B and 20B in the closed positions will be spaced apart the width of the animal's leg relative to the positions illustrated in FIGS. 1-6 as illustrated in in FIG. 4. When the closure blades 44 and 46 swing upwardly in the direction of the arrows 51A and 53A, respectively, the launching arms 86, 87, and the launching arms 89 and 90 concurrently swing downwardly in the direction of the arrows M and N (FIG. 9), respectively, from the positions illustrated in FIGS. 7-9 to the positions illustrated in FIGS. 1-6. As the launching pads 86B, 87B, 89B and 90B swing downwardly against the top surface of the terrain T, the frame 10 and the jaws 18 and 20 carried thereby, will be upwardly catapulted in the direction of the arrow 99 to cause the jaws 18 and 20 to close on the upper portion of the animal's leg L.

It is to be understood that the drawings and descriptive matter are in all cases to be interpreted as merely illustrative of the principles of the invention, rather than as limiting the same in any way, since it is contemplated that various changes may be made in various elements to achieve like results without departing from the spirit of the invention or the scope of the appended claims.

What I claim is:

1. A leg hold trap for trapping the leg of an animal, such as a varment, comprising:
a base having upper and lower sides;
a pair of leg clamping jaws pivotally mounted on said base for swinging movement, above said upper side of the base, in opposite directions between
spread, open positions for receiving the leg of an animal there-between, and
closed, leg clamping positions clamped to opposite sides of the animal's leg;
spring means mounted on said base for yieldably moving said clamping jaws to said closed positions but allowing said jaws to move from said closed positions to said spread, open positions;
jaw holding means for releaseably holding said clamping jaws in said open positions, but releaseable, when engaged by the animal's leg, to allow said spring means to move said clamping jaws from said spread, open positions to said closed positions; and
a pair of launch arm means pivotally mounted for downward swinging movement below said underside of said base about spaced apart transverse axes for upwardly launching the base plate and the clamping jaws in response to said spring means moving said clamping jaws moving from said open positions to said closed leg clamping positions;
said launch arm means including terminal ends disposed between said axes when said clamping jaws are in said open positions.

2. The leghold trap set forth in claim 1 wherein said spring means includes a pair of closure blades mounted on said base for swinging movement about said spaced apart axes between spaced apart positions, when said clamping jaws are in said open positions, and less spaced apart, vertically inclined positions when said clamping jaws are in said closed leg clamping positions; said closure blades each including an aperture there-through receiving said clamping jaws therein.

3. The leghold trap set forth in claim 2 wherein said spring means further includes a coil spring, coiled about each of said transverse axes, one of said coil springs being fixed to each of said closure blades for moving said blades from said spaced apart positions to said less spaced apart vertically inclined positions for urging said clamping jaws to said closed leg clamping positions.

4. The leghold trap set forth in claim 3 wherein said launch arm means includes a launch pad fixed to said blades for swinging movement therewith.

5. The leghold trap set forth in claim 4 wherein said launch pad comprises a flat plate.

6. The leghold trap set forth in claim 3 wherein said launch arm means each includes a bar, having a predetermined breadth fixed to one of said springs and a ground engaging plate, having a breadth substantially greater than said predetermined breadth, coupled to said bar; said frame including two longitudinally spaced, laterally extending pivot rods, said axes being disposed within said pivot rods; said coil springs being received on said pivot rods; said bars including an upper coupling portion adjacent said blades and disposed above said pivot rods.

7. The leghold trap set forth in claim 1 wherein said launch arm means each includes a mounting bar, of predetermined breadth, fixed to said spring means for movement therewith.

8. The leghold trap set forth in claim 7 wherein said launch arm means each includes a ground engageable plate, having a breadth substantially greater than said predetermined breadth, fixed to said mounting bar.

9. The leghold trap set forth in claim 8 wherein said ground engageable plate is continuous throughout its breadth.

10. The leghold trap set forth in claim 8 wherein said ground engageable plate comprises a solid, uninterrupted pad.

11. The leghold trap set forth in claim 1 wherein each of said launch arm means includes a pair of laterally spaced launch arms.

12. The leghold trap set forth in claim 1 wherein each of said launch arm means includes
a pair of laterally spaced apart legs of predetermined breadth fixed to said spring means for movement therewith between generally horizontally disposed positions and vertically inclined positions and
a ground engageable launch pad having a greater predetermined breadth substantially greater than said predetermined breadth.

13. The leghold trap set forth in claim 1 wherein said spring means comprises at least one closure blade, having a jaw receiving opening therein for receiving said clamping jaw, moveable between a generally horizontal position when said clamping jaws are in said open positions, and a vertically inclined position when said clamping jaws are in said closed positions; said launch arm means comprising a pair of laterally spaced apart flat plates generally aligned with and fixed to said blade for movement therewith.

14. The leghold trap set forth in claim 13 wherein said spring means comprises
a pair of said closure blades each having a jaw receiving opening therein; and
a coil spring, disposed about each of said axes and fixed to one of said closure blades for moving said closure blades from said generally horizontal positions to said vertically inclined positions; said launch arm means including a pair of laterally spaced apart flat plates fixed to each of said blades.

15. A leghold trap for trapping the leg of an animal comprising:
a frame;
a pair of leg clamping jaws pivotally mounted on said frame for swinging movement about a pair of laterally spaced apart longitudinally extending axes, in laterally opposite directions, between laterally spread, open positions for receiving the leg of an animal there-between and closed, leg clamping positions clamped to opposite sides of the animal's leg;
a pair of longitudinally spaced apart spring means moveably mounted on said frame for yieldably urging said clamping jaws to move from said open positions to said closed positions but yieldably allowing said jaws to spread from said closed leg clamping positions to said open positions;
jaw holding means for releaseably holding said clamping jaws in said open positions but actuable, when engaged by the animal's leg to release said clamping jaws, to allow said spring means to suddenly and rapidly return said clamping jaws to said closed leg clamping positions; and
launch arm means fixed to each of said spring means for movement therewith between generally horizontal positions when said leg clamping jaws are in said open positions and lowered inclined positions when said spring means moves said jaws to said closed positions to upwardly launch said frame and said clamping jaws as said clamping jaws are moving to said closed leg clamping positions.

16. The leghold trap set forth in claim 15 wherein each of said launch arm means includes a flat plate for engaging the terrain.

17. The leghold trap set forth in claim 15 wherein said launch arm means each includes a mounting bar of predetermined breadth fixed to one of said spring means and a terrain engageable plate, of a breadth greater than said predetermined breadth, fixed to each mounting bar for reacting with the underlying terrain when said spring means moves said jaws to said closed positions to upwardly move said frame and said jaws as the jaws are moving from said open positions to said closed positions.

18. The leghold trap set forth in claim 17 wherein said pair of longitudinally spaced apart spring means comprises a pair of longitudinally, spaced coil springs mounted on longitudinally spaced transversely extending apart axes;
said terrain engageable plates including terminal ends which are disposed between said axes when said jaws are in said open positions and said closed positions.

19. The leghold trap set forth in claim 17 wherein said mounting bar fixed to one of said spring means is laterally spaced from said arms on the other of said mounting bar fixed to the other of said spring means, said terrain engageable plate on said bar fixed to said one spring means extending in a first lateral direction and said terrain engageable plate on said bar fixed to said other spring means extending in a laterally opposite direction opposite said first direction.

20. The leghold trap set forth in claim 15 wherein said launch arm means comprises a pair of launch arms fixed to each of said springs.

21. The leghold trap set forth in claim 20 wherein each arm of each pair of launch arms are laterally spaced apart from each other and laterally spaced from each launch arm on the other pair of launch arms to stabilize the trap when said clamping jaws are in said closed positions.

22. The leghold trap set forth in claim 21 wherein each of said launch arms includes a flat plate thereon for bearing against the ground when said clamping jaws means are in said open positions.

23. The leghold trap set forth in claim 21 wherein each of said launch arms includes a rod of predetermined breadth fixed to one of said spring means and a launching pad of a substantially greater breadth, substantially greater than said predetermined breadth for bearing against the terrain.

24. The leghold trap set forth in claim 23 wherein said launching pad reacts with the underlying terrain as said spring means moves said jaws to said closed positions to upwardly launch said frame and said jaws as said jaws are moving from said open positions to said closed positions.

25. The leghold trap set forth in claim 24 wherein each of said launch arms on each of said spring means is laterally adjacent one of said launch arms on the other of said spring means when said clamping jaws are in said open positions, said launching pads on said laterally adjacent ones of said launch arms extending in laterally opposite directions.

26. The leghold trap set forth in claim 17, including a pair of longitudinally spaced apart, transversely extending pivot rods, having upper and lower sides, mounted to said frame; said pairs of longitudinally spaced apart spring means being swingably mounted on said pivot rods; each of said launch means including a mounting bar, of predetermined breadth passing over said upper side of said mounting rod, fixed to one of said spring means.

27. A leghold trap for trapping an animal's leg comprising:
a base adapted to be disposed on underlying terrain;
a pair of leg clamping jaws pivotally mounted on said base for lateral swinging movement, above the base, in laterally opposite directions between
spaced apart, generally horizontally disposed, open set positions for receiving the animal's leg there-between, and
closed, leg clamping sprung positions clamped to opposite sides of the animal's leg;
first and second spring means mounted on said base for swinging movement in longitudinally opposite directions about longitudinally spaced apart, laterally extending axes between spread, set positions and less spread apart, vertically inclined sprung positions;
said first and second spring means including first and second closure members, respectively, each having an aperture therethrough slidably receiving said clamping jaws for yieldably moving said clamping jaws from said open set positions to said closed, leg clamping sprung positions, but yieldably allowing said clamping jaws to spread from said closed leg clamping sprung positions to said open set positions;
jaw holding means for releaseably holding said leg clamping jaws in said open set positions but actuable when engaged by the animal's leg to release said clamping jaws and allow said spring means to suddenly and rapidly return said leg clamping jaws to said closed leg clamping sprung positions; and
first and second laterally spaced apart launch arms fixed to said first spring means and third and fourth laterally spaced launch arms fixed said second spring means for concurrent downward swinging movement with said first and second spring means, respectively, between generally horizontal positions, when said first and second spring means are in said spread set positions and said jaws are in said open positions and, downwardly vertically inclined positions, when said first and second spring means are in less spread vertically inclined sprung positions and jaws are in said closed leg clamping positions;
said launch arms reacting with the underlying terrain as said arms downwardly swing to suddenly upwardly launch said base and said jaws as said spring means moves said jaws to said closed positions.

28. The leghold trap set forth in claim 27 wherein said first and second launch arms are laterally adjacent said third and fourth launch arms, respectively, when said launch arms are in said horizontal positions.

29. The leghold trap set forth in claim 28 wherein each of said launch arms includes a terrain engageable launching pad, the launching pads on said first and third launching arms extending laterally outwardly in laterally opposite directions and said launching pads on said second and fourth launching arms extending in laterally opposite directions.

30. The leghold trap set forth in claim 28 wherein said first and second launch arms include first and second bars of predetermined breadth fixed to said first closure member and first and second launching pads of a substantially greater predetermined breadth fixed to said first and second bars respectively; said third and fourth launch arms include third and fourth bars of said predetermined breadth fixed to said second closure member and third and fourth launching pads extend in laterally opposite directions from said second and fourth rods, respectively.

31. The leghold trap set forth in claim 30 wherein said launch pads each includes a terminal end which is disposed between said axes.

32. The leghold trap set forth in claim 30 including first and second of longitudinally spaced transversely extending pivot rods having upper and lower sides; said first and second spring means being swingably mounted on said pivot rods; said bars passing over the upper side of the pivot bars.
